(19) United States
(12) Patent Application Publication
(10) Pub. No.: US 2022/0410522 A1
(43) Pub. Date: Dec. 29, 2022

(54) Shaping of containers by folding cardboard sheets

(71) Applicant: SIDEL PARTICIPATIONS, OCTEVILLE-SUR-MER (FR)

(72) Inventors: Vincent RODOT, Corcelles-les-Citeaux (FR); Jeremy DUPONT, Corcelles-les-Citeaux (FR); Guillaume DUCHEMIN, Corcelles-les-Citeaux (FR); Thierry GARNIER, Corcelles-les-Citeaux (FR)

(21) Appl. No.: 17/787,576

(22) PCT Filed: Dec. 17, 2020
(86) PCT No.: PCT/EP2020/086840

§ 371 Date: Jun. 20, 2022

(30) Foreign Application Priority Data
Dec. 18, 2019 (FR) FR1914943

(51) Int. Cl. B31B 50/44; B31B 50/07; B31B 50/04

(52) U.S. Cl. CPC B31B 50/44; B31B 50/07; B31B 50/044; B31B 2110/35

(57) ABSTRACT

A device for shaping containers by folding cardboard sheets, comprising a folding station for folding cardboard sheets, provided with a die; a handling station for handling said sheets from a store to said folding station, with a frame and at least one gripping head that can be moved on the frame and comprises means for grasping and holding said sheet, and also a punch with a complementary shape so as to interact with the inside of said die. The punch comprises a bearing surface for bearing against the bottom of said grasped sheet. The grasping means is mounted so as to be able to move relative to said punch and free to move in at least one plane parallel to said bearing surface. The invention also relates to a corresponding shaping method.

The present invention falls within the field of the shaping of cardboard sheets by folding in order to form containers in which to package one or more products.

For the purposes of the present invention, the term “product” covers a single object. Such a product is a vessel, such as a bottle or a vial, or else a tin or even a cardboard carton. Such products may also be grouped together, positioned in a sleeve pack or “cluster” and/or wrapped in a film. A product may be made of any type of material, in particular of plastic material, of metal or even of glass. A product may be rigid or semirigid. This vessel is intended to contain, and this list is not exhaustive, a fluid, a liquid, powders or granules, in particular of the agri-foodstuff or cosmetic type, or dedicated to housekeeping or body hygiene. A product may exhibit any type of shape, symmetrical or otherwise, regular or irregular.

Such products are obtained on an industrial production line, undergoing a plurality of successive processing operations as they pass through dedicated stations, such as, for example, the blow-molding of plastic bottles or vials, filling and capping, labeling, or else sterilization or pasteurization. Once they have been processed, the finished products are grouped together and packaged in batches, in particular inside a container.

Such a container may be in the form of a cardboard box, dedicated to the packaging of said products. A cardboard box has a rectangular parallelepipedal shape, with an interior volume capable of accommodating a group of products, in a staggered configuration but preferably arranged in a matrix of rows and columns, in a single layer or even several layers of superposed products. Once it has been filled, a cardboard box can be closed at the top or else open, thus forming a tray also referred to as “sleeve pack”.

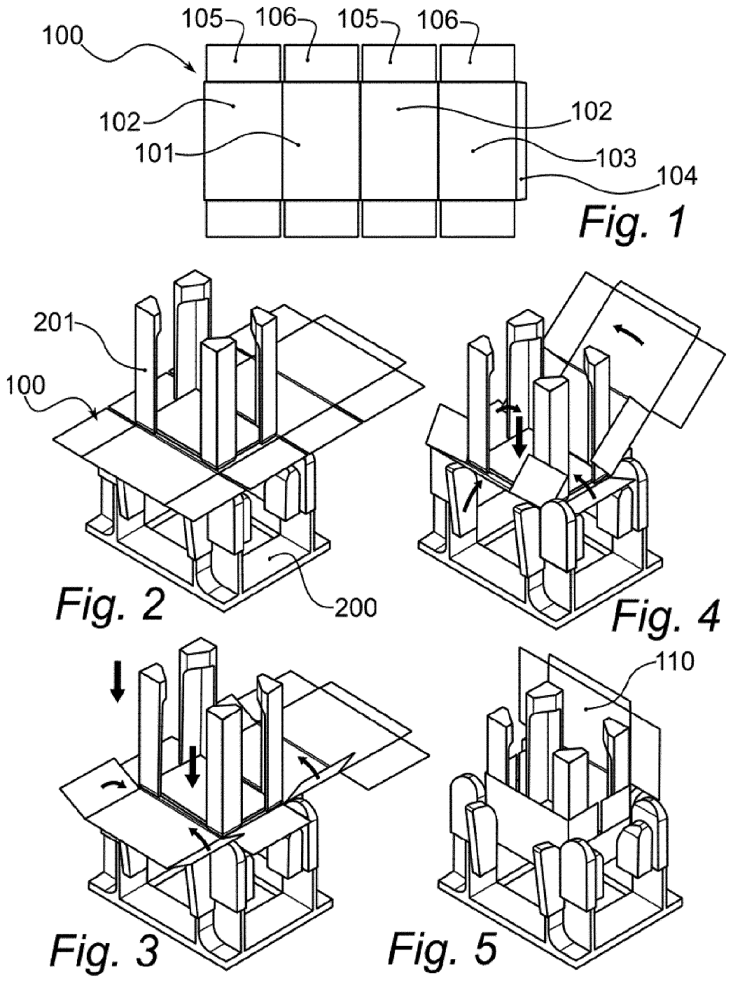

In a known way, the automated making-up of cardboard boxes is done by folding previously precut and preformed cardboard sheets also referred to as “box blanks”. With reference to FIG. 1 which schematically shows a view in elevation of one example of a cardboard sheet 100, laid out flat, it comprises multiple walls including a bottom 101, intended to accommodate the products on its upper face, once the container 110 has been formed. At two of its opposite edges, the bottom 101 comprises two side walls 102.

The cardboard sheet 100 may comprise a top 103, along one edge of one of the side walls 102, located opposite the edge connecting it to said bottom 101.

This top may also comprise a tab 104, which will be coated with glue and turned down against the outside of a side wall 102, at the end of folding upon closure of the container 110 thus formed once products have been introduced inside.

In addition, on either side, the cardboard sheet 100 comprises flaps, at least four of these on each side: on the one hand, vertical flaps 105 connected to each of the side walls 102 and, on the other hand, horizontal flaps 106 connected to the bottom 101 and to the top 103.

The various walls of the sheet 100 are connected by fold lines, extending along the edges at which they join. Said fold lines are made beforehand when said sheet 100 is being cut and facilitate the operations of folding each wall with respect to another wall. That being the case, when the container 110 is being formed, the cardboard sheet 100 is folded by means of multiple successive operations. These folding operations may be carried out by means of dedicated stations and in multiple different ways.

The invention relates specifically to the folding of a cardboard sheet, referred to as “die bottom folding”.

The die bottom folding is done by cold deformation of a material within a press provided with a fixed die in alignment with which a movable punch is displaced.

With reference to FIGS. 2 to 5, schematically showing perspective views of several steps during the die bottom folding of a cardboard sheet 100, the latter is positioned between a die 200 and a punch 201. In particular, as can be seen in FIG. 1, the bottom 101 is positioned facing the die 200 which has a complementary shape, specifically a rectangular parallelepipedal shape, with the fold lines aligned with the inner edge faces of said die 200. For its part, the punch 201 is positioned on the upper face of said bottom 101 and on the inside of the future container 110 to be formed.

During the folding, as can be seen in FIGS. 3 to 5, the punch 201 is then displaced downward relative to the die 200, in particular vertically, so as to apply a pressure against the bottom 101 and thus force the side walls 102 against the inside of the faces of the die 200, in order to fold said side walls 102 toward the inside of the future container 110 and the vertical flaps 105 and horizontal flaps 106 inward, until they are positioned orthogonally with respect to said bottom 101.

More specifically, as can be seen in FIG. 3, the lowering of the punch 201 first of all causes the folding of the four vertical flaps 105 to start by pressing the outer face against dedicated pads having specific configurations and fitted to said die 200. Then, as can be seen in FIG. 4, the two horizontal flaps 106 connected to the bottom 101 begin to be folded against other dedicated pads, so as to outwardly cover the vertical flaps 105. Lastly, as can be seen in FIG. 4, the end of travel of the punch 201 finishes the folding of the side walls 102, and also the vertical flaps 105 and the horizontal flaps 106 linked to the bottom.

It will be noted that, prior to the folding, some surfaces of the walls of the cardboard sheet 100 can be coated with glue, such that the walls are held together once they have been folded. In addition, it is the pressure applied between the die 200 and the punch 201, at the end of folding, which makes it possible to ensure good mutual contact of the glue-coated surfaces.

Once the side walls 102 have been folded orthogonally with respect to said bottom 101, the container 110 is formed and open: the sheet 100 then has an internal volume which is open at the top. The punch 201 is withdrawn and the container 110 is removed from the die 200, in order to introduce products into its interior volume during a packaging operation, in particular boxing operation. Then, if it is present, the top 103 is folded so as to close the container 110, possibly with folding of the tab 104, so as to obtain the final container 110 surrounding and protecting the products contained therein.

A constraint of this type of die bottom folding is the required alignment of the fold lines with the die and the punch, in particular at each corner. Moreover, the precision of such an alignment is around a few millimeters (mm). Failing that, during the folding, an offset risks causing a detrimental deformation of the container, or even tearing of the cardboard material at the time of this operation, in particular when the punch is being lowered.

Specifically, an optimum shape of the container, which is a rectangular parallelepipedal shape, with the walls properly orthogonal is important and needs to be optimum, firstly for the sake of the esthetic appearance and correct packaging of the products, but also and especially when several boxes are to be stacked, in particular on pallets. The deformation of one single box is liable to unbalance a stack of boxes, making them precarious and dangerous for operators to handle.

In this context, the shaping of containers by folding cardboard sheets is done by means of a shaping device.

Such a shaping device comprises a folding station, supplied with cardboard sheets which are shaped there, as described above.

Before they are folded, such cardboard sheets are arranged within a store, in the form of a stack of multiple horizontally or vertically superposed sheets. The sheets are removed one after another during a handling step so as to transport them from said store to said folding station.

This step may consist in removing the sheets one by one and transporting them along guided brackets. However, the brackets are fixed on a frame and have a complementary shape to the cardboard sheets and the containers to be formed. This installation therefore does not make it possible to adapt to different formats of cardboard sheets, or else requires a lengthy intervention time.

At present, due to the diversity of products to be manufactured, production lines must make it possible to manage the manufacture of multiple different product formats. Consequently, these different product formats are packaged in separate containers, with complementary dimensions to said products, and also to the number of products to be packaged per container. A single line must therefore be able to process multiple sheet formats in order to fold them and obtain the desired containers, depending on the products they will accommodate.

To adapt more easily to multiple formats, sheets may be handled via a dedicated station, mounted so as to be movable along multiple axes of displacement, via a multiaxis frame or a multiaxis robot arm. In addition, such a handling station is provided with a gripping head for gripping the sheets individually.

This gripping of each sheet can be done by various grasping means, in particular by suction using suction cups. Each suction cup comes into contact with the face of a sheet and subjects it to suction ensuring that said sheet is held in place with a view to its removal from said store and its displacement toward the shaping station. The suction grip is retained during the folding operation, in order to hold the sheet in place in relation to the die and the punch. Therefore, the suction cups grip the upper face of the bottom, which will remain flat during the movement of the sheet within the die under the action of the movement of the punch.

Once the container has been formed, the suction is stopped in order to release said container. The punch is raised and the container is discharged, for example from below the die, in particular via a conveyor which will transport each container to a downstream product boxing station, before the container is closed.

From the above, in order to optimize the shaping device, the punch is attached to the handling station at the gripping head, integrally with the suction cups. In particular, the suction cups are flush with the bottom side of said punch, so as to interact with the bottom during the gripping. Therefore, the problem of aligning the corners of the cardboard sheet with the die and the punch is made considerably more complicated. This is because, when the sheet starts to be gripped in the store, the punch must be aligned with the corners of the sheet to be grasped, yet the sheet are generally not perfectly aligned in superposition in said store. The stored sheets can have a lateral offset, but also an angular offset, relative to one another. It is therefore necessary to correct this possible offset.

A known solution lies in detecting an offset, upon gripping in the store, from the correct position of the sheet to be grasped, so as to correct the position of the gripping head, in particular to align the punch with the bottom corners.

An alternative solution is to correct the position of the sheet by displacing the store. Such solutions considerably complicate the handling station, with dedicated detection means and increased mobility of the gripping head or of the store, correspondingly increasing the manufacturing-related costs and the time required to configure it.

The object of the invention is to overcome the drawbacks of the prior art by proposing a device for shaping containers by folding cardboard sheets, making it possible to correct any offset between the punch and a sheet, once it has been grasped and at the time of the die bottom folding operation.

In particular, the invention provides for the suction cups to be made freely movable relative to the punch at the gripping head, in order to allow lateral and/or angular adjustment of the sheet under the action of the punch as it lowers into the die.

More specifically, the movement of the suction cups relative to the punch makes the gripping plane movable in at least two degrees of freedom parallel or substantially parallel with respect to the bottom of the grasped sheet.

Thus, when the punch starts to lower, the freedom of movement of the grasping means permits the bottom to be naturally repositioned in alignment with the die, under the effect of the force applied by the interaction between said die and said punch. It is then the forces applied by the die to the sheet during the folding brought about by the movement of the punch that make it possible to reposition the sheet by virtue of the mobility of the grasping means. Thus, the mobility of the grasping means, which may for example be constituted by at least one suction cup, makes it possible to make the fold lines of the bottom of the sheet coincide with the die, reducing the stresses applied to the cardboard material, so as to promote more natural repositioning in alignment with said fold lines. In order to do this, the invention relates to a device for shaping containers by folding cardboard sheets, comprising at least:
a folding station for folding cardboard sheets, said folding station being provided with at least one die;
a handling station for handling said sheets from a store to said folding station, said handling station comprising a frame and at least one gripping head mounted so as to be able to move relative to said frame between said store and the die of said folding station;
said gripping head comprising a means for grasping and holding said sheet;
said gripping head comprising at least one punch with a complementary shape for interacting with the inside of said die, said punch comprising a bearing surface for bearing against the bottom of said grasped sheet.

Such a shaping device is characterized in that said grasping means is mounted so as to be able to move relative to said punch and free to move in at least one plane parallel to said bearing surface of said punch.

According to additional, nonlimiting features, said grasping means may be mounted so as to be able to move in at least two degrees of freedom of movement parallel or substantially parallel relative to said bearing surface.

The grasping means may be incorporated into said punch, which is provided as partially hollow.

Said grasping means may be mounted at the end of a rod mounted in the manner of a ball-jointed connection with respect to the gripping head.

Said shaping device may comprise means for locking said grasping means relative to said punch.

Said grasping means may comprise at least one suction cup acting on said sheet by suction.

The grasping means may comprise multiple suction cups freely displaceable in said plane.

The invention also relates to a method for shaping containers by folding cardboard sheets, wherein at least the following is carried out:
grasping a sheet;
displacing the grasped sheet toward a folding station and positioning the bottom facing a die;
folding the side walls of said sheet by lowering a punch within said die.

Such a shaping method is characterized in that it consists, at the time of folding, in adjusting the position of said bottom relative to said punch, leaving said sheet free to move relative to said punch.

According to additional, nonlimiting features, it is possible to prevent said sheet from moving relative to said punch at least during said displacement of said sheet.

Upon folding, said sheet can be allowed to move again.

Other features and advantages of the invention will become apparent from the following detailed description of nonlimiting embodiments of the invention, with reference to the appended figures, in which:

FIG. 1 schematically represents a simplified view in elevation of an example of a cardboard sheet, configured for die bottom folding;

FIG. 2 schematically represents a perspective view of a first die bottom folding step, showing in particular the positioning of the bottom of the sheet in alignment with the punch and the die;

FIG. 3 schematically represents a view similar to FIG. 2 of a subsequent step, showing in particular the folding of the vertical flaps when the punch is being lowered into the die;

FIG. 4 schematically represents a view similar to FIG. 3 of a subsequent step, showing in particular the folding of the horizontal flaps and the side walls;

FIG. 5 schematically represents a view similar to FIG. 4 of a subsequent step, showing in particular the fully folded container;

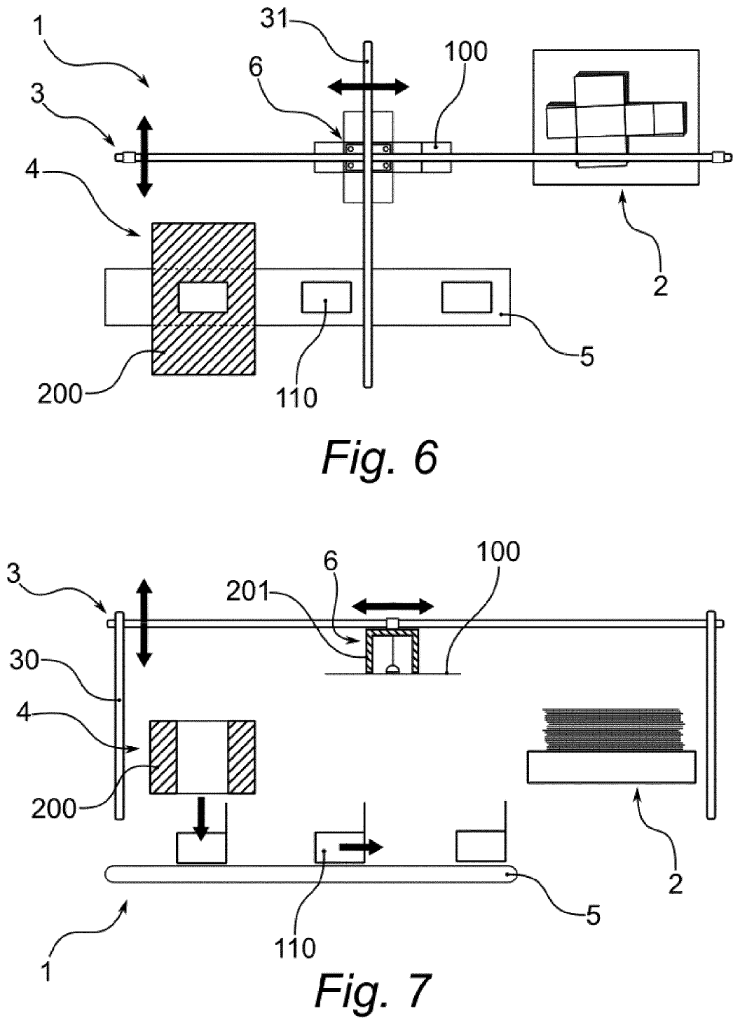

FIG. 6 schematically represents a simplified view in elevation of one embodiment of a shaping device, showing in particular the displacement of a sheet between a store and the folding station;

FIG. 7 schematically represents a simplified view in vertical section of FIG. 6;

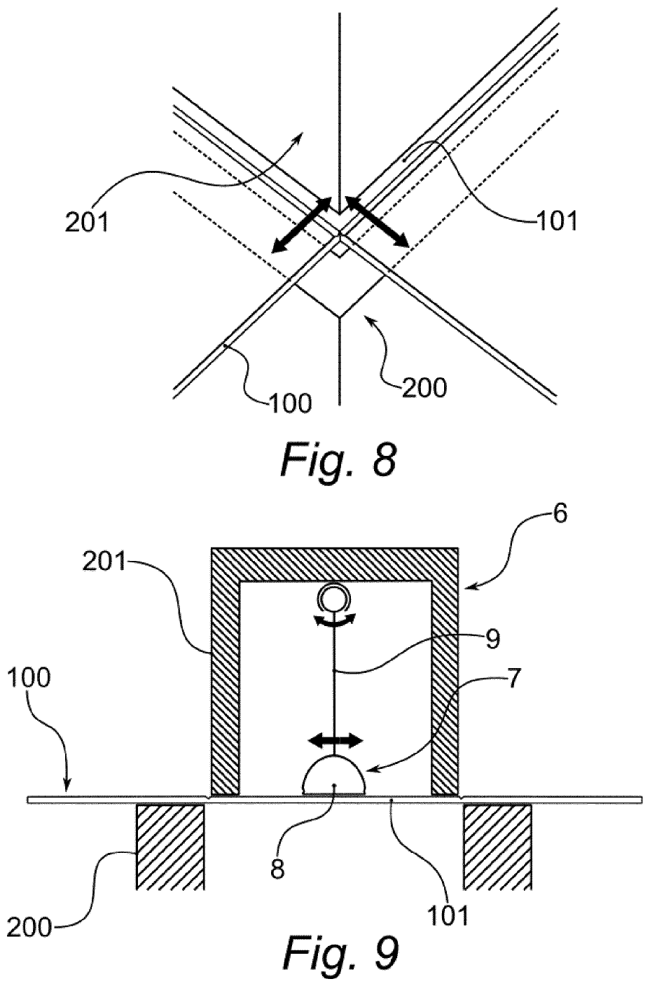

FIG. 8 schematically represents a simplified perspective view of one embodiment, showing in particular the freedom of movement conferred on said corner of a grasped sheet at the time it is folded against the die by the punch;

FIG. 9 schematically represents a simplified view in vertical section of a detail of a gripping head, showing in particular a suction cup mounted in the manner of a ball-jointed connection on said punch;

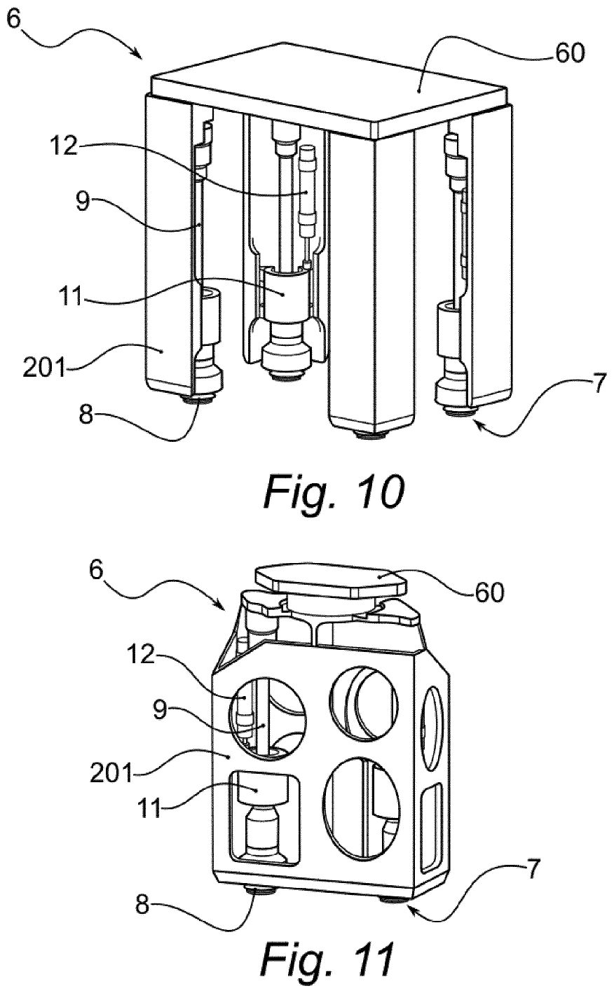

FIG. 10 schematically represents a perspective view of a detail of a first embodiment of said shaping device, showing in particular a gripping head equipped with four suction cups incorporated into a punch formed by four corner pillars;

FIG. 11 schematically represents a perspective view of a detail of a second embodiment of said shaping device, showing in particular a gripping head equipped with two suction cups incorporated into a punch with apertured faces;

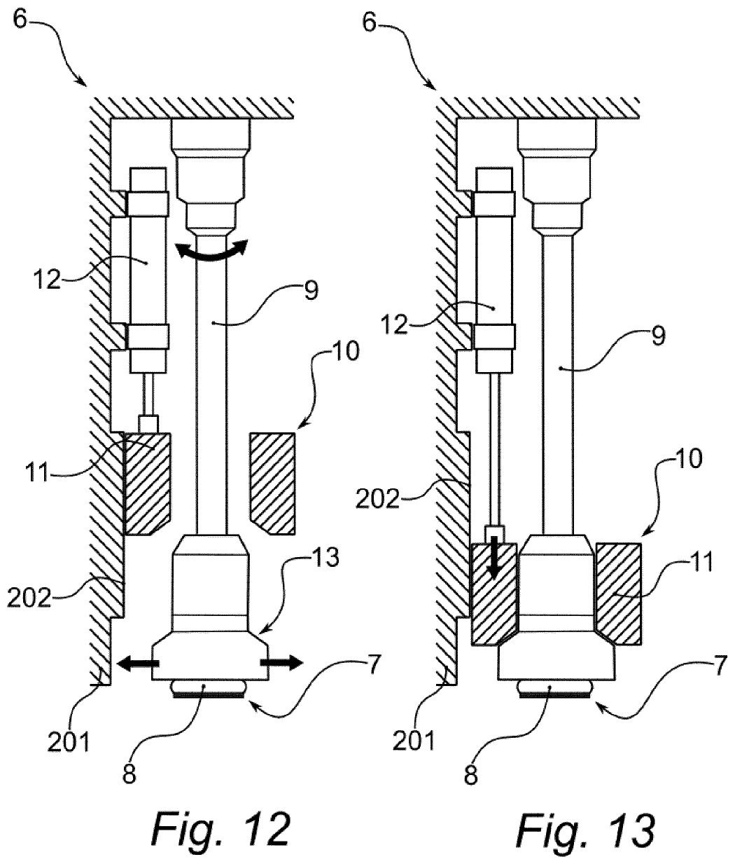

FIG. 12 schematically represents a side view of a detail of a suction cup in an unlocked position, showing in particular the conferred freedom of movement;

FIG. 13 schematically represents a view similar to FIG. 12 in a locked position, showing in particular the lowering of a locking member by actuation of a piston.

The present invention relates to the fabrication of containers 110.

Such a container 110 may be in the form of a cardboard box, dedicated to the packaging of products. A cardboard box has a rectangular parallelepipedal shape, with an interior volume capable of accommodating a group of products, in a staggered configuration but preferably arranged in a matrix of rows and columns, in a single layer or even several layers of superposed products. A cardboard box may be closed at the top or else open, thus forming a tray also referred to as “sleeve pack”.

It will be noted that the term “product” covers a single object. Such a product is a vessel, such as a bottle or a vial, or else a tin or even a cardboard carton. A product may be made of any type of material, in particular of plastic material, of metal or even of glass. A product may be rigid or semirigid. This vessel is intended to contain, and this list is not exhaustive, a fluid, a liquid, powders or granules, in particular of the agri-foodstuff or cosmetic type, or dedicated to housekeeping or body hygiene. A product may exhibit any type of shape, symmetrical or otherwise, regular or irregular.

Such products are obtained on an industrial production line, undergoing a plurality of successive processing operations as they pass through dedicated stations, such as, for example, the blow-molding of plastic bottles or vials, filling and capping, labeling, or else sterilization or pasteurization. Once they have been processed, the finished products are grouped together and packaged in batches, in particular inside containers 110.

The invention relates to the shaping of containers 110 by folding cardboard sheets 100. These cardboard sheets are previously precut and preformed, also referred to as “box blanks”. In the context of the invention, the term “sheet” refers to a cardboard sheet.

In particular, as mentioned previously, a sheet 100 comprises several walls, including a wall which will make up a bottom 101, intended to accommodate the products on the upper face, once the container 110 has been formed. At two of its opposite edges, the bottom 101 comprises two side walls 102.

The sheet 100 may comprise a top 103, along one edge of one of the side walls 102, located opposite the edge connecting it to said bottom 101.

This top may also comprise a tab 104, which will be coated with glue and turned down against the outside of a side wall 102, at the end of folding upon closure of the container 110 thus formed.

In addition, on either side, the sheet 100 comprises flaps, at least four of these on each side: on the one hand, vertical flaps 105 connected to each of the side walls 102 and, on the other hand, horizontal flaps 106 connected to the bottom 101 and to the top 103. The various walls of the sheet 100 are connected by fold lines, extending along the edges at which they join. Said fold lines are made beforehand when said sheet 100 is being cut and facilitate the operations of folding each wall with respect to another wall.

That being the case, when the container 110 is being shaped, the sheet 100 is folded by means of multiple successive operations. In particular, a first folding operation makes it possible to form the container 110 by folding the side walls 102 and also the vertical flaps 105, and then the horizontal flaps 106 located on either side of said bottom 101. This first operation is carried out by die bottom folding. The container 110 is therefore shaped once it has entered the die 200.

In order to do this, the invention relates to a device 1 for shaping containers 110 by folding cardboard sheets 100.

Such a shaping device 1 is located along the production line, between a store 2 supplied with sheets 100 and a downstream station, such as for example a station for packaging products inside the container 110. Once it has been loaded with products, the container 110 will be closed by a dedicated station.

It will be noted that the store 2 is supplied with sheets 100, in particular from bundles. The sheets 100 are placed on a receiving area, superposed horizontally or vertically, or even in an inclined manner, from where they can be removed one by one.

To that end, the shaping device 1 comprises a station 3 for handling said sheets 100 from the store 2.

This handling station 3 transports the sheets 100 by grasping them one by one, or even several at once, so as to bring them to a station dedicated to folding.

Thus, the shaping device 1 comprises at least one folding station 4 for folding sheets 100. One and the same station 4 can make it possible to fold a single sheet or multiple sheets 100 at once.

In order to do this, said folding station is provided with at least one die 200. Such a die 200 comprises an upper face for accommodating a sheet 100, on which the lower face of the sheet 100 can rest. This die 200 comprises a hollow central shape, with complementary dimensions to the bottom 101 of the sheet 100, allowing for a clearance for the thickness of the side walls 102 and the flaps 105, 106 once they have been folded.

As mentioned previously, on either side of the hollow portion, the die 200 comprises pads, which project from the upper face of said die 200 and are shaped so as to allow the successive folding of the vertical flaps 105, then of the side walls 102 and the horizontal flaps 106 located below and connected to the bottom 101. In addition, the pads may be provided as rounded, in order to make the folding of the walls gradual and smooth.

This folding operation takes place under the action of a punch 201.

Such a punch 201 has a complementary shape to the hollow portion of the die 200, so as to allow it to slide inside, allowing for the aforementioned clearance. When a sheet 100 is positioned on the die 200, the punch 201 then applies a force against the bottom 101 of the sheet 100, said bottom 101 being sandwiched between said punch 201 and said die 200, so as to bring about the folding of the various walls. In other words, the punch 201 applies a force against the die 200, which will stress the sheet 100 and fold it. To do this, the punch 201 comprises a bearing surface intended to interact at least with the edge of the bottom 101, for example in its corners as can be seen in FIG. 10 or over its entire internal perimeter as can be seen in FIG. 11. This bearing surface may also comprise areas which make contact with other parts of the bottom 101, in particular located toward the center of said bottom 101, in order to distribute the applied force and to avoid any deformation. In short, the bearing surface of the punch 101 may comprise multiple areas that come into contact with the upper face of the bottom 101, against all or part of its surface.

Once the container 110 has been formed but not closed, the punch 201 is removed from the die 200, making it possible to discharge this container 110, in particular from underneath the die 200 as can be seen in FIG. 7, in particular toward a conveyor 5 which then carries the containers 110 to a boxing station (not shown).

The punch 201 may also be displaced so as to eject the container 110 at another location, such as for example on said conveyor 5.

Beforehand, in order to transport the sheets from the store 2 to the folding station 4, the handling station 3 comprises a frame 30 and at least one gripping head 6 mounted so as to be able to move relative to said frame 30 between said store 2 and the die 200 of said folding station 4.

Such a frame 30 is provided with multiple axes, making it possible to spatially move the gripping head 6, in multiple degrees of movement. In particular, the frame 30 comprises its own dedicated motorization system, permitting the movements necessary to collect the sheets 100 from the store 2 by means of the gripping head 6, displace said head 6 as far as the folding station 4, to put the sheets 100 down there and to return to the store 2 to collect another sheet 100 there. Therefore, nonexhaustively, the frame 30 can allow horizontal translational movements, longitudinally and transversely, and also an upward and downward vertical movement, as is shown schematically in particular in FIGS. 6 and 7.

In particular, the downward vertical movement imparted to the gripping head 6 is used during the folding step. Thus, said gripping head 6 incorporates the at least one punch 201. The latter is therefore transported during the displacements of the gripping head 6 between the folding station 4 and the store 2, and vice versa.

According to one embodiment, as can be seen in FIGS. 6 and 7, the frame 30 comprises multiple guides 31. In that case, the gripping head 6 is secured to a guide 31 or mounted on a carriage which can be moved along one of the guides 31, while the other guides can slide relative to one another.

According to another embodiment, the frame 30 comprises a multiaxis robot arm, at the distal end of which is mounted the gripping head 6 in the form of a tool. Such a robot arm may also be mounted on guides 31. This arm allows in particular better precision when the sheets 100 are being grasped at the store 2.

In addition, the gripping head 6 may comprise a structure 60 which fixedly interacts with the frame 30 and accommodates various embedded components, such as the punch 201 which may be fixed to this structure 60.

In this regard, said gripping head 6 is equipped with a means 7 for grasping and holding said sheet 100. Such a grasping means 7 grasps a sheet 100, in particular at one of its faces, or even a side edge face, and then holds it while it is transported to the folding station 4, preferably by preventing it from shifting in particular during acceleration and deceleration phases.

This grasping means 7 may be located anywhere on the gripping head 6. In particular, the grasping means 7 may be mounted on the structure 60 of said gripping head 6.

Preferably, the grasping means 7 is incorporated in said punch 201, added on with respect to the latter, in particular via the structure 60 of the gripping head 6. In such a configuration, the grasping means 7 is positioned at the distal end of the punch 201, flush with its bearing surface. Therefore, said bearing surface of the punch 201 is completed by the contact surface of the grasping means 7 against the place 100.

According to some embodiments, the bearing surface corresponds to the contact surface between the grasping means 7 and the sheet 100.

According to one embodiment, the punch 201 may be provided as at least partially hollow, delimiting an internal space able to accommodate said grasping means 7 and its fixing to said punch 201 or the structure 60 of the gripping head 6.

The grasping means 7 may be of any type, for example in the form of needles which sufficiently puncture the wall of a sheet 100 to ensure that it is grasped and held. The grasping means 7 may also be a system of electrostatic type.

Preferably, said grasping means 7 comprises at least one suction cup 8, preferably multiple suction cups 8, acting on said sheet 100 by suction. In this way, the vacuum created makes it possible to firmly grasp the sheet 100.

As mentioned above, said suction cup 8 may be arranged so that its suction functions flush with the bearing surface of said punch 201. Therefore, the bearing surface of the punch 201 is at least partially formed by the suction surface of said suction cup 8.

It will be noted that, in the case of multiple suction cups 8, they may be distributed so as to apply vacuums at multiple locations on the sheet 100, in a planar alignment. In addition, this planar alignment is parallel or substantially parallel to the bearing surface of the punch 200.

Thus, the shaping device 1 makes it possible to displace the gripping head 6 as far as the store 2, to grasp a sheet there under the action of the grasping means 7, then to transport it to the folding station 4, to position it on the die 200, to lower the punch 201 and fold the side walls of the sheet 100, in order to form the container 110.

In this regard, during the gripping, the handling station 3 may provide for detecting the position of each sheet 100 in the store 2, in order to align the punch 201 with the bottom 101 of the sheet 100 to be grasped. This alignment makes it possible to compensate for any lateral or angular offset with respect to an optimum position.

In addition, the travel of the handling station 3 is determined so as, when it returns from the store 2, to perfectly align the punch 201 with the die 200.

Advantageously, the invention provides for improving the positioning of the grasped sheet 100, when it is positioned with the punch 201 in alignment with the die 200. In particular, the invention provides for adjusting the position of the bottom 101, so that at least one of its corners is perfectly positioned with respect to the die 200 at the moment the punch 201 is lowered into the die 200.

In order to do this, said grasping means 7 is mounted so as to be able to move relative to said punch 201. In short, the sheet 100 is still grasped and held, but the grasping means 7 can shift, essentially parallel to the punch 201 and its bearing surface. The movement of the grasping means 7 then makes it possible to displace the sheet 100 relative to the punch 201, without shifting the latter relative to the frame 30.

In addition, the grasping means 7 is free to move in at least one plane parallel to said bearing surface of said punch 201. In other words, no motorization system moves the grasping means 7; it is the arrangement of the grasping means 7 on the gripping head which gives it a freedom of movement within a given perimeter.

Indeed, it is the force applied at the moment of folding, when the punch 201 interacts with the die 200, under the action of the movement of the gripping head 6, when the stresses make it possible to reposition the sheet 100, due to the freedom of movement of the grasping means 7. Thus, the sheet 100 repositions itself naturally, coming to rest perfectly between the punch 201 and the die 200 interacting with one another.

It should be noted that when the grasping means 7 is incorporated into the punch 201, the grasping means 7 is fundamentally movable in at least the plane corresponding substantially to the plane of the bearing surface.

Preferably, said grasping means 7 is mounted so as to be able to move in at least two degrees of freedom of movement parallel or substantially parallel to said bearing surface.

FIG. 8 schematically shows an example of repositioning a corner of the sheet 100, this taking place in two orthogonal lateral translational movements. A single translational movement is possible, it being possible for this one to be a result of these orthogonal translational movements: the corner then being displaced at an angle.

It will be noted that the freedom of movement may be limited to a few millimeters, about plus or minus five millimeters (+/−5 mm). In short, the free displacement of the grasping means 7 takes place over a reduced distance, of about 2% to 5% of the dimensions of the bottom 101, in particular of its length or its width.

In order to confer this freedom of movement on the means of the grasping means 7 relative to the punch 201, said grasping means 7 may comprise a mount articulated on the gripping head 6, in particular with respect to the structure 60 of said gripping head 6. Such an articulated joint may be of any type, in particular in the form of a double sliding connection. In other words, the articulated joint comprises two possible ways, preferably orthogonal to one another, for the grasping means 7 to slide.

Preferably, said grasping means 7 is articulated in the manner of a ball-jointed connection, in particular via a cradle or joints. This ball-jointed connection may be mounted on the gripping head 6, in particular on its structure 60 and/or on said punch 201.

Since such a ball-jointed connection confers a curved movement, the invention may make provision to compensate for it in order for the sheet 100 to move in a planar or substantially planar manner. In order to do this, the articulated joint is offset, in particular at one end of the gripping head 6 (for example in the upper part), while the grasping means 7 is located at the opposite end (in the lower part). This offset makes it possible to increase the radius of curvature of the movement of the ball-jointed connection.

Preferably, said grasping means 7 is mounted at the end of a rod 9 mounted in the manner of a ball-jointed connection with respect to the gripping head 6. In short, as can be seen in FIG. 9, the grasping means 7 is fixed to the bottom end of a rod 9, the top, opposite end of which is mounted in a ball-jointed manner on the gripping head 6.

As mentioned above, when the grasping means 7 comprises multiple suction cups 8, they may be mounted independently, each being movable and free to move separately from the other suction cups 8. However, when they are in engagement with the sheet 100 by suction, in particular each suction cup 8 applying a suction against an area of the bottom 101, then the latter acts as a joining surface, uniting the free movement of the suction cups 8 into a coherent whole.

According to another embodiment, the suction cups 8 are secured to one another and jointly freely displaceable in said plane. In order to do this, the suction cups 8 may be interconnected, in particular by a mechanical part, such as a plate or rods.

According to one embodiment, the invention provides for limiting the freedom of movement of the grasping means 7 beyond the time of folding, in particular to avoid any movement of the grasped sheet 100 when the gripping head 6 is displaced by the handling station 3 between the store 2 and the folding station 4, including when it grasps a sheet 100 at said store 2.

In order to do this, the shaping device 1 comprises means 10 for locking said grasping means 7 with respect to the punch 201. Conversely, the locking means 10 make it possible, in an unlocked position, to make the grasping means 7 movable again.

According to a preferred embodiment, the locking means 10 comprise a ring 11, provided as able to move along the rod 9. Such a ring 11 can therefore pass from an unlocked high position to a locked low position, and vice versa.

According to one embodiment, as can be seen in FIGS. 12 and 13, said ring 11 is slidingly guided, in a vertical translational movement, along an inner wall 202 of said punch 201. The ring 11 can therefore only be displaced upward or downward, without being free to move transversely or horizontally.

In addition, the rod 9 passes through the ring 11 and the through-hole has a larger internal diameter than the section of the rod 9, in order to permit the rod 9 to move freely inside the ring 11, and thus the grasping means 7 to move freely.

The actuation of the displacement of the ring 11 may be carried out by any electric, hydraulic or pneumatic motorization means, under the action of a centralized control means, which in particular manages the operation of the shaping device 1.

Preferably, the ring 11 is mounted at the movable end of a pneumatic cylinder 12, specifically at its piston. The opposite end of the cylinder is secured to the gripping head 6. The cylinder 12 may be fixed to the gripping head 6, in particular on an internal wall of the punch 201, as can be seen in particular in FIGS. 12 and 13. The deployment of the cylinder 12 slides the ring 11 toward the locking position, and inversely when it withdraws.

In addition, the locking action between the ring 11 and the grasping means 7 is done mechanically, by the interlocking of parts with complementary shapes.

Preferably, the ring 11 has a frustoconical section on its inner walls, while the grasping means 7 is provided with a peripheral wall 13 provided as inclined. This peripheral wall 13 then extends convergingly, from the bottom to the top. Such a peripheral wall 13 may be formed on a support part of the suction cup 8. Thus, as can be seen in FIG. 13, when the ring 11 slides around the grasping means 7, the frustoconical section of the ring 11 comes into sliding contact with said peripheral wall 13, in particular centering the grasping means 7. The ring 11 continues its travel until it perfectly interlocks with said support part and locks the parts together. In addition, the internal dimensions of said ring 11 correspond in a complementary manner to the external dimensions of said support part, allowing for a clearance so that one can slide with respect to the other.

The invention also relates to a method for shaping containers 110 by folding cardboard sheets 100.

Such a shaping method may be suited to implementation of the shaping device 1 as described above.

During such a shaping method, nonlimitingly, a sheet 100 is grasped. This grasping is done from the store 2 by the gripping head 6. In particular, the sheet 100 is grasped at a face of at least one of its walls, in particular the bottom 101, via at least the grasping means 7.

Then, the grasped sheet 100 is displaced toward the folding station 4. This displacement can be performed by the handling station 3. During this journey, the sheet 100 is held by the grasping means 7.

The sheet having arrived at the folding station 4, the bottom 101 of the sheet 100 is positioned facing the die 200 of said folding station 4.

The side walls of said sheet 100 are then folded by lowering a punch 201 within said die 200. In particular, it is the bearing surface of the punch 201 which applies, against the bottom 101 of the sheet 100, a force necessary to place the walls under stress against the inner edge faces of the die 200 and initiate the folding along lines dedicated to this purpose.

Advantageously, the shaping method provides, at the time of folding, for adjusting the position of said bottom 101 relative to said punch 201, leaving said sheet 100 free to move relative to said punch 201. This freedom of movement is obtained via the grasping means 7 which is mounted so as to be able to move relative to the punch 201 and free to move in at least two degrees of freedom, specifically at least in a plane parallel or substantially parallel to the bearing surface of said punch 201.

Thus, the sheet 100 can be adjusted naturally such that the fold lines coincide with the interlocking of the punch 201 in and against the die 200. The sheet 100 shifts on its own, to take its place perfectly, in particular under the effect of the fold lines, the prestressing of the material of which properly orients the positioning of the sheet 100.

According to a preferred embodiment, when the sheet 100 is displaced, it is not permitted to move relative to the punch 201 and to the gripping head 6.

In order to do this, the shaping method provides for locking the movement of said sheet 100 relative to said punch 201 at least during said displacement of said sheet 100. Conversely, in order to obtain freedom of movement, at the time of folding, the movement of said sheet 100 can be unlocked, as mentioned above.

Locking and unlocking can be done at the grasping means 7.

Thus, the shaping device 2 and the shaping method according to the invention make it possible, by means of a freedom of movement granted to the grasping means 7, in particular or even solely at the time of folding, to reposition the sheet 100, in order to compensate for any offset that occurred before the moment of grasping. It is the interaction of the action of the punch 201 against the bottom 101 and the die 200 which makes it possible to rectify the position of the sheet 100 and reposition it correctly, naturally along the fold lines.

1. A device (1) for shaping containers (110) by folding cardboard sheets (100), comprising at least the following:
a folding station (4) for folding cardboard sheets (100), said folding station (4) being provided with at least one die (200);
a handling station (3) for handling said sheets (100) from a store (2) to said folding station (4), said handling station (3) comprising a frame (30) and at least one gripping head (6) mounted so as to be able to move relative to said frame (30) between said store (2) and the die (200) of said folding station (4);
said gripping head (6) comprising a means (7) for grasping and holding said sheet (100),
said gripping head (6) comprising at least one punch (201) with a complementary shape for interacting with the inside of said die (200),
said punch (201) comprising a bearing surface for bearing against the bottom (101) of said grasped sheet (100),
wherein said grasping means (7) is mounted so as to be able to move relative to said punch (201) and free to move in at least one plane parallel to said bearing surface of said punch (201).

2. The shaping device (1) as claimed in claim 1, wherein said grasping means (7) is mounted so as to be able to move in at least two degrees of freedom of movement parallel or substantially parallel to said bearing surface.

3. The shaping device (1) as claimed in claim 1, wherein the grasping means (7) is incorporated into said punch (201), which is provided as partially hollow.

4. The shaping device (1) as claimed in claim 1, wherein said grasping means (7) is mounted at the end of a rod (9) mounted in the manner of a ball-jointed connection with respect to the gripping head (6).

5. The shaping device (1) as claimed in claim 1, further comprising a lock (10) for locking said grasping means (7) with respect to said punch (201).

6. The shaping device (1) as claimed in claim 5, wherein said grasping means (7) comprises at least one suction cup (8) acting on said sheet (100) by suction.

7. The shaping device (1) as claimed in claim 1, wherein the grasping means (7) comprises multiple suction cups (8) freely displacable in said plane.

8. A method for shaping containers (110) by folding cardboard sheets (100), comprising at least the following:
grasping a sheet (100);
displacing the grasped sheet (100) toward a folding station (4) and positioning the bottom (101) facing a die (200);
folding the side walls of said sheet (100) by lowering a punch (201) within said die (200);
wherein, at the time of folding, in adjusting the position of said bottom (101) relative to said punch (201), leaving said sheet (100) free to move relative to said punch (201).

9. The shaping method as claimed in claim 8, wherein the movement of said sheet (100) relative to said punch (201) is locked, at least during said displacement of said sheet (100).

10. The shaping method as claimed in claim 9, wherein, at the time of folding, the movement of said sheet (100) is unlocked.

11. The shaping device (1) as claimed in claim 2, wherein the grasping means (7) is incorporated into said punch (201), which is provided as partially hollow.

12. The shaping device (1) as claimed in a claim 2, wherein said grasping means (7) is mounted at the end of a rod (9) mounted in the manner of a ball-jointed connection with respect to the gripping head (6).

13. The shaping device (1) as claimed in a claim 3, wherein said grasping means (7) is mounted at the end of a rod (9) mounted in the manner of a ball-jointed connection with respect to the gripping head (6).

14. The shaping device (1) as claimed in claim 2, further comprising a lock (10) for locking said grasping means (7) with respect to said punch (201).

15. The shaping device (1) as claimed in claim 3, further comprising a lock (10) for locking said grasping means (7) with respect to said punch (201).

16. The shaping device (1) as claimed in claim 4, further comprising a lock (10) for locking said grasping means (7) with respect to said punch (201).

17. The shaping device (1) as claimed in claim 2, wherein the grasping means (7) comprises multiple suction cups (8) freely displacable in said plane.

18. The shaping device (1) as claimed in claim 3, wherein the grasping means (7) comprises multiple suction cups (8) freely displacable in said plane.

19. The shaping device (1) as claimed in claim 4, wherein the grasping means (7) comprises multiple suction cups (8) freely displacable in said plane.

20. The shaping device (1) as claimed in claim 5, wherein the grasping means (7) comprises multiple suction cups (8) freely displacable in said plane.
